(19) United States
(12) Patent Application Publication
(10) Pub. No.: US 2007/0250365 A1
(43) Pub. Date: Oct. 25, 2007

(54) Grid computing systems and methods thereof

(75) Inventors: Anirban Chakrabarti, West Bengal (IN); Dheepak Ramanujam, Tamilnadu (IN); Shakeb Ali, Uttar Pradesh (IN); Ira Gupta, Jharkhand (IN); Anirban Ghosh, Bangalore (IN)

Correspondence Address: NIXON PEABODY, LLP, 401 9TH STREET, NW, SUITE 900, WASHINGTON, DC, 20004-2128, US

(73) Assignee: Infosys Technologies Ltd., Bangalore (IN)

(21) Appl. No.: 11/407,906

(22) Filed: Apr. 21, 2006

(51) Int. Cl. G06F 9/46

(52) U.S. Cl. 705/8

(57) ABSTRACT

A grid computing system, method, and computer program product, adapted to execute at least one workflow having a set of predefined operating parameters and including an execution module comprising a plurality of devices having a plurality of heterogeneous resources, wherein the plurality of devices is adapted to execute the at least one job by integrating the plurality of heterogeneous resources. The system further includes at least one grid workflow module. The grid workflow module includes a graphical user interface to provide at least one user to initiate and manage the at least one workflow based on the set of predefined operating parameters and the plurality of heterogeneous resources. Furthermore, the grid workflow module includes a manager module adapted to partition the at least one workflow into multiple jobs prior to the execution of the at least one workflow.

### BACKGROUND OF THE INVENTION

1. Field of the Invention

The invention relates generally to a field of workflow management system and more particularly, to a system and method for efficiently managing workflow in a grid computing system.

2. Discussion of the Background

A Grid is described as a distributed network of computer system, which comprises of heterogeneous and non-dedicated elements. The heterogeneity of a grid is not only defined in terms of computing elements and operating systems but also in terms of implementation of policies, policy decisions and the environment. A long-term vision of enterprise grid computing community is non dedicated seamless interoperability of different disparate systems which may be part of the same organization or different organizations.

Traditionally, applications were developed for a target environment that was homogeneous, reliable, secure, and centrally managed. However, last decade has seen the development and growth of internet technologies, which resulted in the advent of collaborative computing and data sharing. As a result, newer modes of interaction have evolved resulting in the need and use of distributed resources. Organizational resources may be data or information resources, compute resources, infrastructure resources, human resources and so on. Recently, organizations have begun to realize the benefits of outsourcing, where nonessential elements of their information technology requirements are outsourced to various forms of service providers. These have resulted in requirements for distributed application development and deployment on heterogeneous environments.

Today, applications and middleware are typically developed for a specific platform (e.g., Windows NT, Linux, UNIX, a mainframe, J2EE, Microsoft NET) that provides a hosting and runtime environment for applications. The capabilities provided by such platforms may range from integrated resource management functions to database integration, clustering services, security, workload management, and problem determination—with different implementations, semantic behaviors, for these functions on different platforms.

The continuing decentralization and distribution of software, hardware, and human resources make it essential that a desired quality of service (QoS) is achieved, whether measured in terms of common security requirements, distributed workflow and resource management performance, guaranteed job latency, coordinated fail-over, or other metrics—on resources assembled dynamically from enterprise systems, service provider systems, and customer systems. New abstractions and concepts are required that allow applications to access and share resources and services across distributed, wide area networks.

These problems have been for some time a central concern of the developers of distributed systems for large-scale scientific research. Work within this community has led to the development of grid technologies, which address precisely these problems and which are seeing widespread and successful adoption for scientific and technical computing.

Conventionally, grid workflows are defined by simple linear relationships among the different compute and data intensive tasks, which are then submitted to a grid/cluster broker/cluster for execution of the tasks on the grid computing nodes. However there are several bottlenecks and problems associated with this method. Firstly, many applications have requirements in terms of QoS, security, trust, etc. which need to be managed through the interaction between the applications and the underlying grid infrastructure. The problem of manageability is closely related to that of integration. Since grids bring together software components, frameworks, middleware and hardware elements, integrating them together often entails gluing together systems which may not be designed and developed with that in mind.

Therefore, present workflow systems do not integrate well with the complex systems working in the enterprise and hence unusable from the enterprise perspective. Secondly, the present system may not be directly applied to enterprises because they may not provide a web services interface which has become an industry standard. In addition to this, the relationships among the jobs are linear and the present system does not manage complicated conditional relationships. Thirdly, many industries require active collaborations among the different stakeholders who may be in different departments and across geographies. This amount to collaboration carried out in enterprises and not managed in current grid workflow solutions.

Accordingly, there is a need for a technique that solves the problem of integration, manageability, and collaboration.

### SUMMARY OF THE INVENTION

In one embodiment of the present technique, a grid computing system is disclosed. The system is adapted to execute at least one workflow having a set of predefined operating parameters and includes an execution module comprising a plurality of devices having a plurality of heterogeneous resources, wherein the plurality of devices is adapted to execute the at least one job by integrating the plurality of heterogeneous resources. The system further includes at least one grid workflow module. The grid workflow module includes a graphical user interface to provide at least one user to initiate and manage the at least one workflow based on the set of predefined operating parameters and the plurality of heterogeneous resources. Furthermore, the grid workflow module includes a manager module adapted to partition the at least one workflow into multiple jobs prior to the execution of the at least one workflow. The system also includes a middleware module adapted to map the at least one job to the plurality of heterogeneous resources.

In another embodiment of the present technique, a method of executing at least one workflow having a set of predefined operating parameters is disclosed. The method includes submitting the at least one workflow using a graphical user interface and partitioning the at least one workflow into a plurality of jobs using the manager module. The method further includes initiating and managing the plurality of jobs based on the set of predefined operating parameters via at least one grid workflow module and mapping the plurality of jobs with a plurality of heterogeneous resources disposed in a plurality of devices. Furthermore, the method includes executing the plurality of jobs by integrating the plurality of heterogeneous resources. It should be noted that the graphical user interface is adapted to monitor and control a current status of the execution of the at least one workflow.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram illustrating the various components of a grid computing system adapted to execute at least one workflow, in accordance with one embodiment of the present technique;

FIG. 2 is a block diagram illustrating architecture of the various components and subcomponents of a grid computing system adapted to execute at least one workflow, in accordance with one embodiment of the present technique; and

FIG. 3 is a flowchart illustrating a method of executing at least one workflow having a set of predefined operating parameters, in accordance with one embodiment of the present technique.

### DETAILED DESCRIPTION OF THE PREFERRED EMBODIMENTS

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present invention could be implemented with either greater or lesser specificity, depending on the needs of the user. Further, some of the features of the present invention could be used to advantage without the corresponding use of other features described in the following paragraphs. As such, the present description should be considered as merely illustrative of the principles of the present invention and not in limitation thereof, since the present invention is defined solely by the claims which follow.

The present invention relates to a grid computing system adapted to execute at least one workflow using multiple heterogeneous resources present in multiple devices configured to be connected via a communication network.

A workflow is a description of a process in terms of the steps or tasks or jobs that comprise the process. Like a flow diagram, a workflow describes the steps in a process and the dependency among steps. Each step is a task to be performed in the process. A workflow definition may include a description of the desired behavior that occurs when a step is executed and a description of step dependencies in terms of steps and data. A step dependency may include a dependency on the state of one or more steps and/or the state or value of one or more data variables.

In addition, the workflow definition describes dependencies among the steps in the process. These dependencies may include dependencies among steps based on the state of another step such as whether another step has been performed successfully or is currently being performed. The dependency may also be based on the state of data, such as whether data is ready to be used as input to a step, or whether the value of a specified data variable calculated during a step has a pre-defined value.

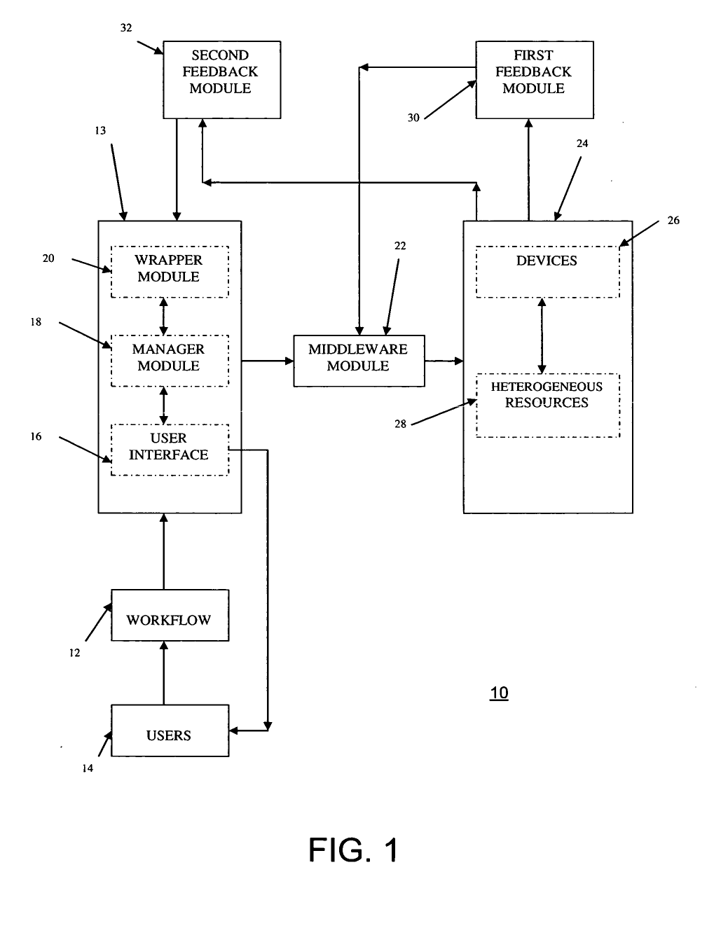

Referring now to FIG. 1, a block diagram illustrating the various components of a grid computing system 10 adapted to execute at least one workflow, in accordance with one embodiment of the present technique is disclosed. As illustrated, the system 10 includes at least one workflow 12 and at least one user 14. Though reference is made to one user, multiple users with one or more user interfaces may also be used for managing and executing a single workflow 12. The system 10 further includes a grid workflow module 13 adapted for executing and managing the workflow 12. The grid workflow module 13 includes a graphical user interface module 16 and the manager module 18. It should be noted that though reference is made to the graphical user interface module 16, any other user interface may also be used for the present system 10. The user 14 provides the at least one workflow 12 as input through the graphical user interface module 16. The grid workflow module 13 further includes a wrapper module 20. The system 10 also includes a middleware module 22 and an execution module 24. The execution module 24 includes multiple devices 26 having a plurality of heterogeneous resources 28 and wherein the multiple devices 26 may be adapted to execute the at least one workflow 12 by integrating the plurality of heterogeneous resources 28. The system 10 further includes a first feedback module 30 and a second feedback module 32. The details of the above components will be explained in the subsequent sections to follow.

As will be appreciated by person skilled in the art, the system 10 enables a user 14 to interactively create the workflow 12 definition using the graphical user interface 16, including a graphical description of the workflow 12 as well as a description of work performed by steps in the workflow 12 and dependency among those steps. The graphical description of a workflow 12 is based on a flow diagram paradigm where graphical representations of step types and flow lines illustrate the process. While creating a graphical description of the workflow 12, the user 14 specifies the workflow definition in terms of dependency relationships. After the workflow definition is created, user 14 of the system 10 may then use an instance of the workflow 12 as a guide to interactively perform a process.

The graphical user interface (GUI) 16 monitors the current status of the actual execution of the workflow 12. In addition to this, the GUI 16 also controls the execution of the workflow 12 and the user 14 may also modify the workflow 12 during the execution of the workflow 12. Furthermore, the user 14 may specify quality of service parameters using the GUI. The user 14 specifies the workflow 12 via the GUI using an extensible markup language (XML) via the XML file. In one embodiment of the present technique, the user 14 may at any point acquire dynamic information on the progress of the execution of the workflow 12 via the grid workflow module 13 and this information may be displayed in the GUI 16.

As mentioned above, the system 10 includes the execution module 24 adapted to execute the workflow 12 depending on the functionalities of the other components of the system 10. The execution module 24 includes multiple devices 26, each having multiple heterogeneous resources 28. It should be noted that a device may include at least one of a mobile device or fixed device or combinations thereof. The resources 28 may include various applications capability present on each device. The multiple devices 26 are adapted to execute the workflow 12 by integrating the heterogeneous resources 28 of the devices 26.

The manager module 18 or also referred as a workflow manager module in the grid workflow module 13 is adapted to partition the at least one workflow 12 into multiple jobs prior to the execution of the workflow 12. The partition of the workflow 12 into multiple jobs may increase the efficiency of the execution of the workflow 12. In addition to this, the manager module 18 may be adapted to maintain a status of execution of the multiple jobs. The status may be graphically displayed in the GUI. It should be noted that a job may include at least one of standalone application, or a database query, or a web service client or combinations thereof.

As illustrated in FIG. 1, the first feedback module 30 may be adapted to monitor at least one dynamic system parameter of the heterogeneous resources 28. The system parameters may include CPU usage, memory usage, available bandwidth, and some other user defined parameters like trust, availability, etc. In addition to this, the first feedback module also provides feedback to the middleware module 22 on the resources or machines the tasks or the jobs are running, the status of the jobs, and so on. Furthermore, the second feedback module 32 may be adapted to monitor multiple performance parameters for the workflow 12 and provide feedback to the grid workflow module 13. The performance parameters include the status of the job, the exceptions presented by the job, the running time of each job, and so on.

In the case of multiple users, the grid workflow module 13 may be implemented in a network configuration enabling each user to access and interact with a shared instance of a workflow 12. The grid workflow module 13 enforces the dependencies among steps and data based on the workflow definition. As steps are performed, the system maintains and graphically depicts the state of steps and data in the process. The grid workflow module 13 also maintains historical and statistical data about the process.

Furthermore, the grid workflow module 13 may be adapted to manage exception parameters of the workflow 12. Exception managing is one of the most important features of grid workflow module 13. There may be possibly two ways in which exceptions may be specified through the description of the workflow 12 from the GUI 16. They may be defined as on failure and on custom action. During failure exception managing, the user 14 is able to specify the actions the workflow 12 should take in case of job failures. This condition is specified by the user in the initial stage of defining the job properties. There are three actions that the workflow 12 may take in case of job failures. Firstly, the job will be submitted “n” number of times where n is specified by the user 14. Secondly, if the job fails even after “n” tries then the workflow may either be terminated abruptly. Thirdly, the failure may be ignored and the execution of the rest of the workflow 12 may be carried out. All the information may be supplied with a grid workflow language (GWLang). The grid workflow module 13 manages the exception parameters. In case of multiple resubmissions of the job, the wrapper module 20 disposed in the grid workflow module 13 invokes multiple job resubmissions. This may be done to optimize the multiple web services. The details of the wrapper module 20 will be explained in further sections to follow.

In the custom exception parameters managing, the users 14 should be aware of the different return values that the job would provide. If the user is aware of the return values, the user may create the workflow 12 by supplying a condition in the definition of the workflow 12 in the GUI 16. An exemplary illustration of the condition is provided below:
<application_id.status {condition} {value}>in

Unlike the previous case, this gives the user lots of flexibility, as the users may specify different actions (like submission of a different job, submission of the same job with different input files etc.).

As indicated earlier, the grid workflow module 13 also includes the wrapper module 20 adapted for mapping a plurality of heterogeneous jobs to standard jobs. In the present context, heterogeneous jobs mean that the nature and the architecture of the jobs may differ significantly. For example, jobs may be written in platform independent language like Java, or other languages. Similarly, jobs may be of type Web Services, stand alone or even a database call. The wrapper module 20 invokes such heterogeneous jobs through a standardized format, which may be a common format specified in Java or any other platform independent language. In one embodiment of the present technique, during execution of any job, the wrapper module 20 is first called which performs three specific activities in addition to providing a standardized job interface for executing the heterogeneous job. Firstly, it may take care of file staging where the files are dynamically brought to the execution node by the wrapper module 20 by calling operating system specific transport functions. Secondly, in case of job splitting, the wrapper module 20 splits up the data required by the job into smaller chunks of data so that the job may take advantage of the multiple hosts or nodes available. Thirdly the wrapper module 20 sets all the environmental variables, which may be required by the job.

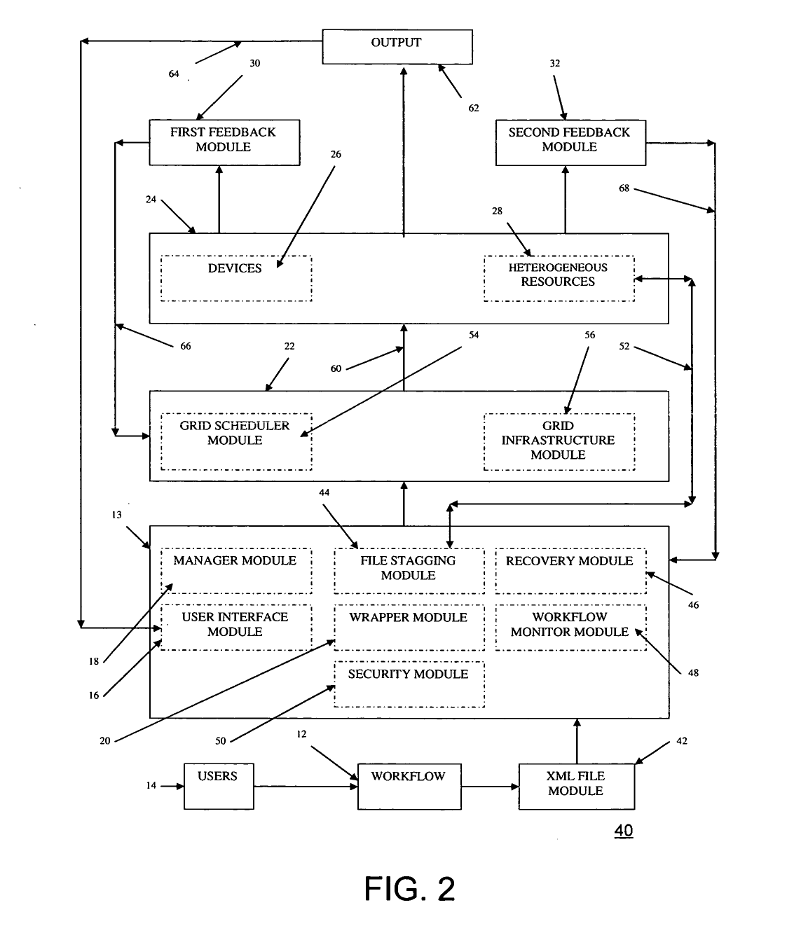

Referring now to FIG. 2, a block diagram illustrating architecture of the various components and subcomponents of a grid computing system 40 adapted to execute at least one workflow, in accordance with one embodiment of the present technique is disclosed. As illustrated in FIG. 2, the system 40 depicts most of the components discussed with reference to FIG. 1 above. However, as described earlier, the system 40 includes the grid workflow module 13 through which the multiple users 14 submit the workflow 12 via the XML file module 42. Likewise, the grid workflow module 13 includes a file staging module 44, a recovery engine module 46, a workflow monitor module 48, a wrapper module 20, a security module 50 apart from the manager module 18 and the user interface module 16. The functionalities of the various modules will be explained in the following sections.

It should be noted that many jobs or applications require files for execution purposes. It is not efficient for the users to supply the file during the job or task submission to the workflow. This problem is addressed by the file staging module 44. The file staging module 44 may be adapted to extract a required data or file from the heterogeneous resources 28. This is indicated by reference numeral 52. The grid workflow module 13 manages file staging across multiple devices by transferring the file from the remote system to the execution module. The remote system may be a file server where the file or the data is located. The file staging module 44 moves the data or the file from the remote system to the system where the job or the task is getting executed.

In one embodiment of the present technique, the file staging module 44 includes a directory service which includes the location of the files or the data in the grid system. Each file or data is given identification or a Unique Resource Identification (URI) which is unique within the grid system. The user needs to supply the URI of the data that needs to be moved from the remote system to the execution system. The user interface module 16 interacts with a directory service to get the information of all the URIs located in the grid workflow module 13.

The recovery engine module 46 may be adapted to provide a backup resource for the at least one grid workflow module 13. The recovery engine module 46 consists of a heart beat service and an alternate job submission service. The heart beat service constantly sends a heart beat to the manager module 18 to see if the manager module 18 is alive or not. If the heart beat service does not get the reply within a configurable amount of time, the workflow 12 may be resubmitted to the backup manager module (not shown for clarity) through the alternate job submission service.

As indicated earlier, the manager module 18 in the grid workflow module 13 may be adapted to partition the at least one workflow into multiple jobs prior to the execution of the workflow 12. The partition of the workflow 12 into multiple jobs may increase the efficiency of the execution of the workflow 12. In addition to this, the manager module 18 may be adapted to maintain a status of execution of the multiple jobs. The status may be graphically displayed in the user interface module 16. It should be noted that a job may include at least one of standalone application, or a database query, or a web service client or combinations thereof.

The security module 50 may be adapted to verify authenticity from the user of the multiple devices prior to the execution of the jobs and maintain confidentiality of all transactions in the workflow. The security module 50 consists of a password checking module which checks the passwords of users stored in a LDAP server over a SSL channel. The LDAP server is also configured to provide a session key and a signed X.509 certificate certifying that the username and password are valid. The security module 50 then sends all the data including the XML file module 42 specifying the relationships, and the input files encrypted using a session key generated by a server. This maintains the confidentiality of the transactions. The session key may be further encrypted with the private key of the grid manager module 13. When the manager 18 receives the files from the user 14, it extracts the session key using its own private key, and then decrypts the other information using the session key.

In one implementation of the present technique, the grid workflow module 13 further includes a recovery engine module 46 configured to provide backup resources for the grid workflow module 13. As mentioned earlier, the recovery engine module 46 consists of a heart beat service and an alternate job submission service. The heart beat service constantly sends a heart beat to the manager module 18 to see if the manager is alive or not. If the heart beat service does not get the reply within a configurable amount of time, the workflow is resubmitted to the backup manager through the alternate job submission service.

As explained above, the system 40 further includes the middleware module 22 configured to map the at least one job to the multiple heterogeneous resources 28. The mapping provides guidance to utilize the capability of the heterogeneous resources 28 based on the requirement of the job. The middleware module 22 further includes a grid scheduler module 54 and a grid infrastructure module 56.

As indicated earlier the grid workflow module 13 maps the different heterogeneous resources 28 to standardized jobs using the wrapper module 20. Heterogeneous jobs mean that the nature and the architecture of the jobs may differ significantly. For example, jobs may be written in platform independent language like Java, or other languages. Similarly, the jobs may be of type web services, stand alone jobs or even a database call. The wrapper module 20 invokes such heterogeneous jobs through a standardized format which may be a common format specified in Java or any other platform independent language. During execution of any job, the wrapper module 20 may perform three specific activities in addition to providing a standardized job interface for executing the heterogeneous job. Firstly, it takes care of file staging where the files are dynamically brought to the execution node by the wrapper module 20 by calling operating system specific transport functions. Secondly, in case of job splitting, the wrapper may split up the data required by the job into smaller chunks of data so that the job may take advantage of the multiple hosts or nodes available. Thirdly the wrapper module 20 sets all the environmental variables, which may be required by the job.

In one embodiment of the present technique, the grid scheduler module 54 may be adapted to schedule at least one job among the multiple devices. The grid scheduler 54 may be adapted to schedule jobs to the grid resources. The scheduler module 54 may include priority based scheduling, where different jobs are assigned different priorities, or based on match making where the jobs are assigned to resources based on the constraints assigned to the jobs. The constraints on the job may be operating system, memory size, and so on. The scheduler module 54 may also schedule jobs based on different scheduling algorithms like backfilling, earliest job first and other algorithms.

In one implementation of the present technique, the grid infrastructure module 56 may be adapted to act as an interface with the grid scheduler module 54 for managing quality of service parameters specified by the at least one user. The different quality of service (QoS) parameters may include parameters like latency where an user specifies that the job should be completed within a certain time. In addition to this, the, user may specify a certain trust rating for the job meaning that the job cannot run on resources having trust rating lesser than that of the job.

As illustrated, the system 40 includes the execution module 24 comprising multiple devices 26 with multiple heterogeneous resources 28. The details of the devices 26 and the resources 28 have already been explained in the previous sections.

While, the preceding discussions relates to the various components of the system, the following sections provides an exemplary embodiment of the implementation of the present technique using the various components.

The user 14 specifies the workflow 12 with a predefined quality of service parameters through the user interface module 16 via the XML file module 42. The grid workflow module 13 segregates the workflow 12 into number of jobs in the grid workflow module 13 and transfers the output to the middleware module 22. In one implementation of the present technique, the file staging module 44 present in the grid workflow module 13 may be adapted for extracting a required data or file required by the jobs comprising the workflow 12 from the heterogeneous resources 28.

In the middleware module 22, the grid scheduler module 54 schedules the job among the devices 26 based on the resources 28 of the devices 26. Further, the grid infrastructure module 56 interfaces with the grid scheduler module 54 for managing the quality of service parameters specified by the user 14.

The result 60 generated from the middleware module 22 may be transferred to the execution module 24. In the execution module 24, the final output 62 may be executed in any of the devices 26 using the resources of the devices 26. The output 62 generated by the execution module 24 may be displayed in the user interface as indicated with reference numeral 64. Likewise, the final output 62 may be monitored to determine at least one dynamic system parameter of the resources using the first feedback module 30. The feedback generated from the first feedback module 30 may be provided to the middleware module 22 for determining the effectiveness of the workflow and for further modification of the workflow. This is generally represented by reference numeral 66.

Likewise, the final output 62 may be monitored to determine the performance parameters for the workflow using the second feedback module 32. The output 62 generated from the second feedback module 32 may be provided to the grid workflow module 13 for determining the effectiveness of the workflow and for further modification of the workflow. This is generally represented by reference numeral 68.

Following is an illustrative exemplary example of the XML file. The example is simple where a list of files are defined and later used by the applications. The XML file becomes bigger if there are conditions or loops and multiple applications. Though the application uses multiple files, only one file has been defined as an exemplary illustrative example.

<?xml version=“1.0” encoding=“UTF-8” ?>
<gwl:gwlang xmlns:gwl=“http://infosys.com/gwlangnew”>
<gwl:resource>
<gwl:files>
<gwl:id>File1</gwl:id>
<gwl:host>localhost</gwl:host>
<gwl:path>c:\blast</gwl:path>
<gwl:name>blast.exe</gwl:name>
</gwl:files>
<gwl:resource>
<gwl:applist>
<gwl:application>
<gwl:id>Application1</gwl:id>
<gwl:type>standalone</gwl:type>
<gwl:iolist>
<gwl:args>
<gwl:file>File2</gwl:file>
</gwl:args>
</gwl:iolist>
<gwl:formattedfile>ff1.txt</gwl:formattedfile>
<gwl:exec>File1</gwl:exec>
<gwl:os>Linux</gwl:os>
<gwl:envr>
<gwl:envar>
<gwl:name>globus_home</gwl:name>
<gwl:value>c:\home\globus</gwl:value>
</gwl:envar>
</gwl:envr>
</gwl:application>
</gwl:applist>

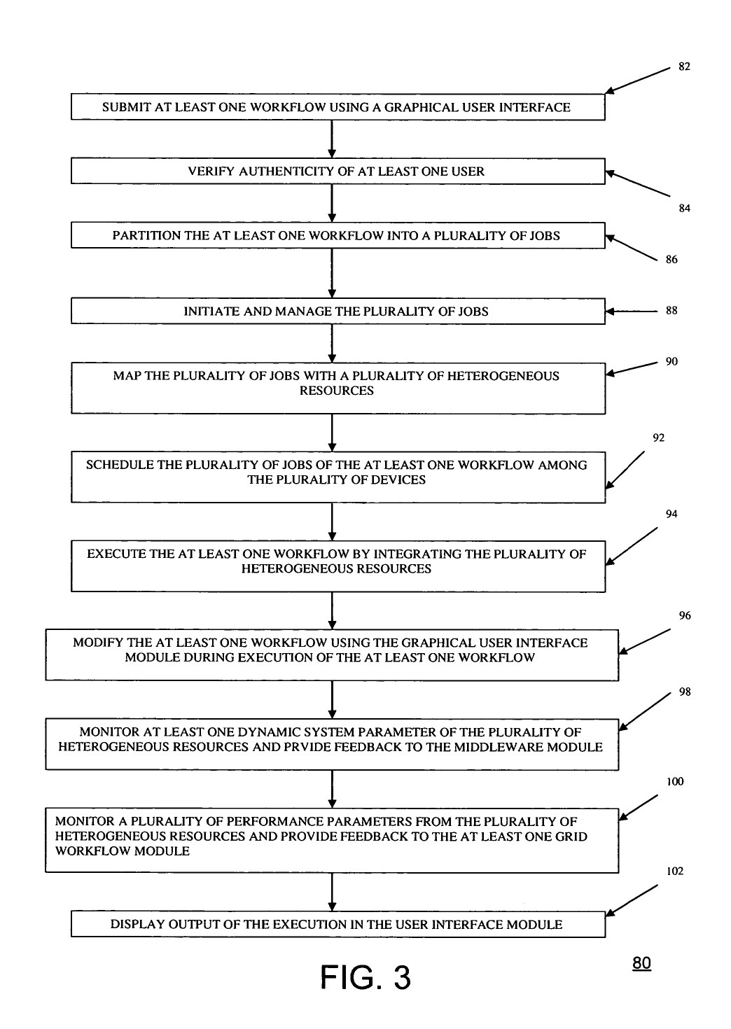

FIG. 3 is a flowchart illustrating a method 80 of executing at least one workflow having a set of predefined operating parameters, in accordance with one embodiment of the present technique. As illustrated, the method proceeds with step 82, wherein the at least one user submits the workflow in any of the device using a graphical user interface. At step 84, the device verifies the authenticity of the user. The authenticity may also include determining authorization of the user. In one implementation of the present technique, the authenticity of the users is verified prior to the execution of the jobs using the security module. Further, the security module also maintains confidentiality of all transactions in the workflow.

At step 86, the workflow may be partitioned into multiple jobs based on the capability of the heterogeneous resources available on the device.

The method continues in step 88, wherein the device initiates and manages the multiple jobs based on the set of predefined operating parameters. This may be executed in the grid workflow module. In one embodiment of the present technique, the grid workflow module may further manage exception parameters of the at least one workflow. In addition to this, the grid workflow module may extract a required data from the plurality of heterogeneous resources via the file staging module present on the grid workflow module.

At step 90, the multiple jobs are mapped with the heterogeneous resources disposed in the multiple devices. The ability of the system to map jobs to heterogeneous resources on demand helps in reducing the total cost of ownership of the system, as idle machines may be utilized to run jobs as long as the job is able to run on those machines. At step, 92 the multiple jobs of the workflow may be scheduled among the multiple devices using the grid scheduler module disposed in the middleware module thus maintaining load balancing across the grid system. It should be noted that in one embodiment of the present technique, the middleware module may randomly change priority of the jobs based on the set of predefined operating parameters using the graphical user interface. Moreover, the user interface may be adapted to monitor and control a current status of the execution of the at least one workflow.

At step 94, the workflow may be executed by integrating the heterogeneous resources of the devices. As will be appreciated by those skilled in the art, the use may at any stage of the execution of the workflow acquire dynamic information on progress of the execution the jobs and this data may be displayed in the graphical user interface.

At step 96, the workflow may be modified by the user based on the predefined set of operating parameters and quality of service specified by the user. The modification may also be based on the output generated after implementation of the workflow. In certain other implementation of the present technique, the data of the multiple jobs are divided into number of portions for reducing the computational time for executing the at least one workflow.

At step 98, the first feedback module monitors at least one dynamic system parameter of the multiple heterogeneous resources and provides feedback to the middleware module. Likewise at step 100, the second feedback module monitors multiple performance parameters from the heterogeneous resources and provide feedback to the at least one grid workflow module.

It should be noted that in certain embodiment of the present technique, the recovery engine module present in the grid workflow module provides a backup for the grid workflow module in case the server which hosts the grid workflow manager fails. The method continues in step 102, wherein the output of the execution may be displayed in the user interface.

As will be appreciated by those of ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. It should be note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The sequence of instructions as explained in the method steps may include but not limited to, program code adapted for program code adapted for establishing the communication network between multiple devices. The sequence of instruction further include program code adapted for exchanging the capabilities of the at least one application resource prior to invoking the task. It also includes program code adapted for selecting at least one optimal application resource for performing the task based on the capabilities of the at least one application resource.

The sequence of instruction further includes program code adapted for allocating the task among the devices based on the selection of the at least one optimal application and a program code adapted for performing the task based on the allocation of the at least one optimal application resource among the devices.

In one embodiment of the present technique, the sequence of instruction may include program code adapted for submitting the at least one workflow using the graphical user interface and program code adapted for partitioning the at least one workflow into a plurality of jobs. The sequence of instruction may further include program code adapted for initiating and managing the plurality of jobs based on the set of predefined operating parameters via at least one grid workflow module. In addition to this, sequence of instruction may include program code adapted for mapping the plurality of jobs with a plurality of heterogeneous resources disposed in a plurality of devices and program code adapted for executing the plurality of jobs by integrating the plurality of heterogeneous resources.

In certain implementation of the present technique, the sequence of instructions may include program code adapted for randomly changing priority of the plurality of jobs based on the set of predefined operating parameters using the graphical user interface. Further, it may include program code adapted for acquiring dynamic information on progress of the execution the plurality of jobs displayed in the graphical user interface.

Furthermore, the sequence of instructions may include program code adapted for scheduling the plurality of jobs of the at least one workflow among the plurality of devices using a grid scheduler module disposed in a middleware module.

Likewise, in one embodiment of the present technique, the sequence of instructions may include program code adapted for monitoring at least one dynamic system parameter of the plurality of heterogeneous resources and providing feedback to the middleware module using the first feedback module.

In another embodiment of the present technique, the sequence of instructions may include program code adapted for monitoring the plurality of performance parameters from the plurality of heterogeneous resources and providing feedback to the at least one grid workflow module using the second feedback module.

In yet another embodiment of the present technique, the sequence of instruction may include program code adapted for modifying the at least one workflow using the graphical user interface during the execution of the at least one workflow. Moreover, in another embodiment of the present technique, the instructions may include program code adapted for managing exception parameters of the at least one workflow. The details of the exception parameters are explained in earlier sections above.

As will be appreciated by a person skilled in the art, the various implementations of the present technique provide a variety of advantages. For example, the technique helps in reducing cost in two ways. Firstly, through automation of business processes it is able to reduce cost of manual intervention. Secondly, through by using the underlying scheduler module the system can efficiently execute jobs so that more jobs can be handled by the same grid infrastructure. Also, the technique helps in easy and seamless infrastructure enhancements as the infrastructure is virtualized to the end user and applications. Lastly, the technique helps in incremental deployment of grid where the process of moving to a grid from a current scenario can be virtualized, as the technique works even with existing enterprise applications and systems.

While, the following description id presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

What we claim is:

1. A grid computing system adapted to execute at least one workflow having a set of predefined operating parameters, comprising:
an execution module comprising a plurality of devices having a plurality of heterogeneous resources, wherein the plurality of devices is adapted to execute the at least one workflow by integrating the plurality of heterogeneous resources;
at least one grid workflow module comprising:
a graphical user interface adapted to provide at least one user to initiate and manage the at least one workflow based on the set of predefined operating parameters and the plurality of heterogeneous resources;
a manager module adapted to partition the at least one workflow into a plurality of jobs prior to the execution of the at least one workflow; and
a middleware module adapted to map the plurality of jobs to the plurality of heterogeneous resources;
wherein the graphical user interface is adapted to monitor and control a status of execution of the at least one workflow.

2. The grid computing system as recited in claim 1, wherein the plurality of devices include at least one of mobile device or fixed device or combinations thereof.

3. The grid computing system as recited in claim 1, wherein the grid workflow module further comprising a workflow monitor module adapted to provide feedback of monitored parameters to the graphical user interface.

4. The grid computing system as recited in claim 1, wherein the middleware module further comprising a grid scheduler module adapted to schedule the plurality of jobs among the plurality of devices.

5. The grid computing system as recited in claim 4, wherein the middleware module further comprising a grid infrastructure module adapted to interface with grid scheduler module for managing quality of service (QoS) parameters specified by the at least one user.

6. The grid computing system as recited in claim 1, wherein the at least one workflow is specified by the at least one user in an extensible mark-up language (XML) file.

7. The grid computing system as recited in claim 1, further comprising a first feedback module adapted to monitor at least one dynamic system parameter of the plurality of heterogeneous resources and provide feedback to the middleware module.

8. The grid computing system as recited in claim 1, further comprising a second feedback module adapted to monitor a plurality of performance parameters for the at least one workflow from the plurality of heterogeneous resources and provide feedback to the grid workflow module.

9. The grid computing system as recited in claim 1, wherein the at least one user is adapted for modifying the at least one workflow using the graphical user interface during the execution of the at least one workflow.

10. The grid computing system as recited in claim 1, wherein the at least one grid workflow module is adapted to manage exception parameters of the at least one workflow.

11. The grid computing system as recited in claim 1, wherein the manager module is adapted to maintain the status of execution of the plurality of jobs in the at least one workflow.

12. The grid computing system as recited in claim 1, wherein the at least one grid workflow module comprises a file staging module adapted to extract a required data from the plurality of heterogeneous resources.

13. The grid computing system as recited in claim 1, wherein the at least one grid workflow module further comprising a recovery engine module configured to provide a backup resource for the at least one grid workflow module.

14. The grid computing system as recited in claim 1, wherein the plurality of jobs includes at least one of standalone application, or a database or a web service or combinations thereof.

15. The grid computing system as recited in claim 1, wherein the grid workflow module further comprising a wrapper module adapted for mapping a plurality of heterogeneous jobs to standard jobs.

16. A method of executing at least one workflow having a set of predefined operating parameters, the method comprising the steps of:
submitting the at least one workflow using a graphical user interface;
partitioning the at least one workflow into a plurality of jobs using a manager module;
initiating and managing the plurality of jobs based on the set of predefined operating parameters via at least one grid workflow module;
mapping the plurality of jobs with a plurality of heterogeneous resources disposed in a plurality of devices; and
executing the at least one workflow by integrating the plurality of heterogeneous resources of the plurality of devices;
wherein the graphical user interface is adapted to monitor and control a status of the execution of the at least one workflow.

17. The method as recited in claim 16, further comprising randomly changing priority of the plurality of jobs based on the set of predefined operating parameters using the graphical user interface.

18. The method as recited in claim 16, further comprising acquiring dynamic information on progress of the execution the plurality of jobs displayed in the graphical user interface.

19. The method as recited in claim 16, further comprising verifying authenticity from at least one user of the plurality of devices prior to the execution of the plurality of jobs and maintaining confidentiality of all transactions in the at least one workflow using a security module.

20. The method as recited in claim 16, further comprising mapping a plurality of heterogeneous jobs to standard jobs using a wrapper module.

21. The method as recited in claim 16, further comprising scheduling the plurality of jobs of the at least one workflow among the plurality of devices using a grid scheduler module disposed in a middleware module.

22. The method as recited in claim 21, further comprising interfacing with grid scheduler module for managing quality of service (QoS) parameters specified by the at least one user using a grid infrastructure module.

23. The method as recited in claim 21, further comprising monitoring at least one dynamic system parameter of the plurality of heterogeneous resources and providing feedback to the middleware module using a first feedback module.

24. The method as recited in claim 16, further comprising monitoring a plurality of performance parameters from the plurality of heterogeneous resources and providing feedback to the at least one grid workflow module using a second feedback module.

25. The method as recited in claim 16, further comprising modifying the at least one workflow using the graphical user interface during the execution of the at least one workflow.

26. The method as recited in claim 16, wherein the at least one grid workflow module further comprising managing exception parameters of the at least one workflow.

27. The method as recited in claim 16, wherein the at least one grid workflow module further comprising extracting a required data from the plurality of heterogeneous resources via a file staging module.

28. The method as recited in claim 16, further comprising providing a backup arrangement for the at least one grid workflow module via a recovery engine module.

29. The method as recited in claim 16, further comprising dividing a data of the plurality of jobs into multiple portions for reducing computational time for executing the at least one workflow.

30. A computer storage device tangibly embodying a plurality of instructions stored in a computer readable medium for performing a method for executing at least one workflow having a set of predefined operating parameters, the method comprising:
program code adapted for submitting the at least one workflow using a graphical user interface;
program code adapted for partitioning the at least one workflow into a plurality of jobs;
program code adapted for initiating and managing the plurality of jobs based on the set of predefined operating parameters via at least one grid workflow module;
program code adapted for mapping the plurality of jobs with a plurality of heterogeneous resources disposed in a plurality of devices; and
program code adapted for executing the plurality of jobs by integrating the plurality of heterogeneous resources;
wherein the graphical user interface is adapted to monitor and control a status of the execution of the at least one workflow.

31. The computer storage device as recited in claim 30, further comprising program code adapted for randomly changing priority of the plurality of jobs based on the set of predefined operating parameters using the graphical user interface.

32. The computer storage device as recited in claim 30, further comprising program code adapted for acquiring dynamic information on progress of the execution the plurality of jobs displayed in the graphical user interface.

33. The computer storage device as recited in claim 30, further comprising program code adapted for scheduling the plurality of jobs of the at least one workflow among the plurality of devices using a grid scheduler module disposed in a middleware module.

34. The computer storage device as recited in claim 30, further comprising program code adapted for monitoring at least one dynamic system parameter of the plurality of heterogeneous resources and providing feedback to the middleware module using a first feedback module.

35. The computer storage device as recited in claim 30, further comprising program code adapted for monitoring a plurality of performance parameters from the plurality of heterogeneous resources and providing feedback to the at least one grid workflow module using a second feedback module.

36. The computer storage device as recited in claim 30, further comprising program code adapted for modifying the at least one workflow using the graphical user interface during the execution of the at least one workflow.

37. The computer storage device as recited in claim 30, wherein the at least one grid workflow module further comprising program code adapted for managing exception parameters of the at least one workflow.

38. The computer storage device as recited in claim 30, further comprising program code adapted for mapping a plurality of heterogeneous jobs to standard jobs using a wrapper module.
